(19) United States
(12) Patent Application Publication
(10) Pub. No.: US 2019/0101511 A1
(43) Pub. Date: Apr. 4, 2019

(54) ACOUSTIC TESTING SYSTEM WITH HIGHLY CONDUCTIVE TRANSDUCER/ROD-END INTERFACE

(71) Applicant: United States of America as Represented by The Secretary of The Army, Alexandria, VA (US)

(72) Inventors: Richard W. Haskins, Raymond, MS (US); James A. Evans, Tallulah, LA (US); Ken Switzer, Vicksburg, MS (US)

(21) Appl. No.: 15/815,471

(22) Filed: Nov. 16, 2017

Related U.S. Application Data
(60) Provisional application No. 62/566,409, filed on Sep. 30, 2017.

(51) Int. Cl. G01N 29/28; G01N 29/04; G01N 29/07

(52) U.S. Cl. CPC G01N 29/28; G01N 29/041; G01N 2291/101; G01N 2291/044; G01N 29/07

(57) ABSTRACT

The invention is an apparatus and method for making a highly conductive transducer/rod-end interface structure to improve the accuracy of acoustic testing of the rod. In various embodiments, the invention includes creating an object from a metal cast affixed the rod end surface to compensate for planar variations and surface irregularities in the surface of the rod. It has been shown that the presence of planar deviation and surface irregularities materially interferes with acoustic testing.

### CROSS-REFERENCE TO RELATED APPLICATIONS

This patent application claims the benefit of U.S. Provisional Application No. 62/566,409 filed Sep. 30, 2017. The above application is incorporated by reference herein.

### STATEMENT REGARDING FEDERALLY SPONSORED RESEARCH OR DEVELOPMENT

The invention described herein was made by an employee of the United States Government and may be manufactured and used by the Government of the United States of America for governmental purposes without the payment of any royalties thereon or therefore.

### FIELD OF INVENTION

This invention pertains to the field of measurement using acoustic signals, and more specifically to an apparatus for creating an interface on a rod to more accurately detect faults.

### BACKGROUND OF THE INVENTION

The U.S. Army Corps of Engineers is responsible for maintaining the structural integrity of a large number of dams, canals and other structures.

Tainter gates are commonly used to control water flow. The gates are large curved plates affixed to a bearing arm. The bearing arm pivots around a metal structure embedded in concrete referred to as a “trunnion rod.” Trunnion rods are subject to failure when a microcrack reaches a critical threshold. These cracks may go undetected. Visual inspection and ultrasonic testing are difficult because the trunnion rods are generally embedded in concrete.

Engineers at the U.S. Army Engineer Research and Development Center (ERDC) have developed an in situ, ultrasonic guided wave method that can be used to determine the condition of the entire length of the trunnion rod.

The method couples an ultrasonic transducer with the trunnion rod at the exposed end of the rod that is not embedded in concrete. The acoustic signal enters the rod and the signal is returned to the transducer at the “transducer/rod-end interface.”

Ultrasonic coupling performance is substantially compromised if the surface of the trunnion rod at the interface is non-planar or has surface deformities (roughness). Surface roughness interferes with the accuracy of the ultrasonic guided wave method and many other non-destructive testing (NDT) methods.

To inject the necessary high frequency ultrasonic energy into the test piece, the rod-end interface must be made relatively smooth or considerable energy will be lost at the transducer/rod-end interface.

### BRIEF SUMMARY OF THE INVENTION

The invention is an apparatus and method for making a highly conductive transducer/rod-end interface structure to improve the accuracy of acoustic testing of the rod. In various embodiments, the invention includes creating an object from a cast which compensates for planar variations in the surface of the rod and surface irregularities.

The method further includes additional steps to reduce surface roughness and non-planar deviation through mechanical processes.

In various embodiments, the method may include forming an additional sealant layer to reduce the presence of air between surfaces due to surface irregularities.

In various embodiments, the highly conductive transducer/rod-end interface apparatus includes a smooth, flat outer surface, and an inner surface that is conformed to the surface irregularities of the rod end surface during the casting process.

### BRIEF DESCRIPTION OF SEVERAL VIEWS OF THE DRAWING(S)

FIG. 1 illustrates trunnion rod anchors placed inside ducts embedded in concrete (prior art).

FIG. 2 illustrates an exemplary method for making a highly conductive transducer/rod-end interface structure.

FIG. 3 illustrates an exemplary system for ultrasonically testing a trunnion rod in situ using a highly conductive transducer/rod-end interface conductive cap.

FIG. 4 illustrates an exemplary embodiment of the cast used for molding the conductive cap.

FIG. 5 illustrates how acoustic trunnion rod testing is affected by variations in surface roughness, rod end surface condition, rod diameter, and rod length.

### TERMS OF ART

As used herein, the term “affixed” means attached, either permanently or temporarily.

As used herein, the term “approximately” means within a variance from a stated range or quantity which does not alter the effectiveness or teach against the relationship that is disclosed by the range or quantity.

As used herein, the term “contoured surface” means a surface which has a structure, texture, or features corresponding to the structure, texture, or features of another surface.

As used herein, the term “exposed” means freely accessible and not encased in another structure or material.

As used herein, the term “fault” means cracks or any other structural alteration due to stress or wear.

As used herein, the term “in situ” means at the trunnion rod's location.

As used herein, the term “non-planar” means a surface with area defined by multiple vertices where all vertices do not lie on the same plane.

As used herein, the term “planar” means a surface with area defined by multiple vertices where all vertices lie on the same plane.

As used herein, the term “planar deviation” means a variance from a planar surface.

As used herein, the term “sealant layer” means viscous or non-viscous layer of material which conforms to surface irregulates on the surface to which it is applied, and eliminates or reduces the presence of air between layers.

As used herein, the term “smooth” means flat or planar.

As used herein, the term “substantially” means all or less than all, but within a range variation that does not materially alter the result, function, or critical nature of the claimed element.

As used herein, the term “system” means an apparatus with physically or geographically distributed component part which operate interdependently to accomplish a function, process or result.

### DETAILED DESCRIPTION OF THE INVENTION

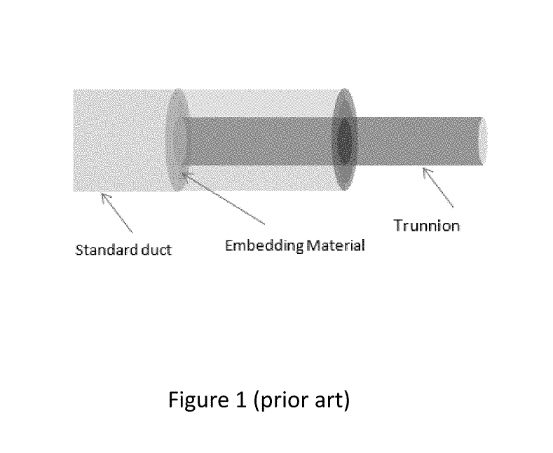

FIG. 1 illustrates trunnion rod anchors placed inside ducts embedded in concrete (prior art). The trunnion rod is placed in a duct that is embedded in a concrete. After the concrete has set and cured, embedding material is added to secure the trunnion. Subsequent to securing, the annular space between the post-tensioning steel and duct is grouted for corrosion protection.

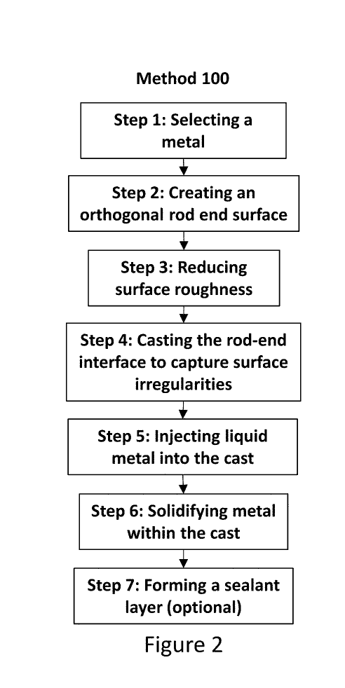

FIG. 2 illustrates exemplary method 100 for making a highly conductive transducer/rod-end interface structure. In various embodiments, the highly conductive interface structure created by method 100 improves the accuracy of nondestructive testing (NDT) methods. In various embodiments, method 100 can be used in other cases where rough surfaces prevent a transducer from contacting the surface evenly; the surface that contacts the transducer does not need to be the end of a trunnion rod.

Step 1 is the step of selecting the optimum metal from which to form a transducer/rod-end interface. In various embodiments, a metal may be selected from metals such as gallium, Field's metal, Rose's metal, and Wood's metal as the coupling material. Metals are selected which have the ability to transition from a liquid state to a hardened metalized state at temperatures slightly above normal ambient temperatures, which allows a casting of the rod-end to be made at the field site. Once the casting material solidifies, the acoustical impedance of the coupling material compares favorably with the acoustical impedance of the rod.

In one exemplary embodiment, gallium may be used on a rough-cut rod sample. Gallium has a melting point that is approximately 37.8° C. (100° F.). When tested as a coupling material, gallium revealed losses on the order of 60%.

In another embodiment, Field's metal may be used as a coupling material. Field's metal is a fusible alloy that becomes liquid at approximately 62° C. (144° F.). This higher melting point results in less unintentional melting and quicker solidification after casting. Field's metal is a eutectic alloy of bismuth, indium, and tin, with the following percentages by weight: 32.5% Bi, 51% In, 16.5% Sn, but proportions may vary. Field's metal and similar metals having low viscosity when melted and low volume change during state transitions may be deemed equivalent. Unlike Rose's metal and Wood's metal, Field's metal is considered nontoxic.

In various embodiments, transmission measurements may be performed on coupling materials with shear wave transducers. In one embodiment, results indicated a compressional wave speed of 2617 m/sec and a shear wave speed of 1065 m/sec. Using a density of g/cm³, the resulting acoustical impedance was calculated to be 20.6 MRayls. The tensile strength is approximately 33 MPa, the Young's modulus 25 GPa, and the value of poisons ratio is approximately 0.4. However, the foregoing results may vary depending on the coupling material used and structural properties of the rod end.

Step 2 step of creating a rod end surface orthogonal to the rod length. In various embodiments, this step is accomplished by cutting the rough end of a trunnion rod orthogonally to the length of the trunnion rod so that the rod surface is flattened and more planar. The angle between the trunnion rod length and the plane of the trunnion rod end being equal to 90 degrees creates less signal reduction and optimizes test results. Having an angle closer to 90 degrees causes less signal reduction and more accurate testing.

Step 3 is the optional step of reducing surface roughness.

The coupling performance of various metals, including Field's metal, degrades with increasing surface roughness due to destructive phase interactions at the metal and rod interface.

In various embodiments, the step of reducing surface roughness by steps such as grinding may be optional. Various tools and methods known in the art may be used to reduce surface roughness, including a band saw or grinder may be used to grind the rough end of the trunnion rod.

In some embodiments, it may be critical to reduce surface roughness. Surface variation on the order of 0.01 inches may create losses due to scattering and destructive phase interactions. In one exemplary embodiment, using a Field's metal conductive cap allowed the system to receive backwall reflections on most rough-cut rod surfaces.

Step 4 is the step of casting the rod-end to capture surface irregularities. In Step 4, the cast utilizes the surface of the rough end of the trunnion rod to create a corresponding irregular inner surface in the conductive cap.

In various embodiments, the cast has an open end opposite the rough end of the trunnion rod. A cast with an open end opposite the trunnion rod depends on the force of gravity to form the flat backing of the metal coupling that will contact the transducer face, which requires the trunnion rod to be oriented vertically.

In various embodiments, the cast has a smooth side opposite the rough end of the trunnion rod. A cast that includes a smooth side opposite the trunnion rod allows the trunnion rod to be oriented at any angle during casting.

In various embodiments, the cast may include a vent hole at the top of the cast cavity, to provide an escape route for excess liquid metal injected into the cast cavity. In various embodiments, adjustments may be made to the cast to change the thickness of the resulting metal conductive cap.

Step 5 is the step of injecting liquid metal into the cast. In various embodiments, portable propane stoves such as those used in backpacking can be utilized to heat the metal to its melting point, including Field's metal to its 62° C. (144° F.) melting point. In various embodiments, the liquid metal is placed in a large syringe, directed into the cast, and then pressurized with the plunger until the cast cavity is filled and the liquid material exits the small vent hole at the top of the cast cavity.

Step 6 is the step of solidifying metal within the cast to cause the liquid metal to transition to a solid state. In various embodiments, the liquid metal in the cast is Field's metal, which solidifies in 1 to 2 minutes at room temperature. Once the liquid metal has cooled and solidified, the casting apparatus can be removed. In some embodiments, conductive caps do not form an adhesive bond with the rod and the casting apparatus and can be removed easily once the liquid metal has solidified.

Step 7 is the optional step of forming a sealant layer.

In some embodiments, sealant may fill any air gaps between the trunnion rod and conductive cap, and between the conductive cap and the transducer to form good ultrasonic coupling. In various embodiments, the sealant may be water or grease, including petroleum grease.

In various embodiments, optimum coupling may occur when a large-diameter transducer is placed on the flat end of the anchor rod.

According to theory, the calculated loss due to impedance mismatch between the transducer faceplate and Field's metal is 10% reflected or 90% transmitted. Likewise, the energy in the Field's metal traveling into the anchor rod undergoes 13.8% reflection or 86.2% transmission efficiency. Combining these two layers, the overall transmitted and reflected energy through the Field's metal is 77.6% and 22.4%, respectively. Because the ultrasonic energy must travel through these layers twice (in transmission and reception), the overall loss from reflections into and out of the conductive cap is approximately 40% from the transducer into the rod and back. Mode conversion losses at the end of the rod can be conservatively approximated to be less than 5%.

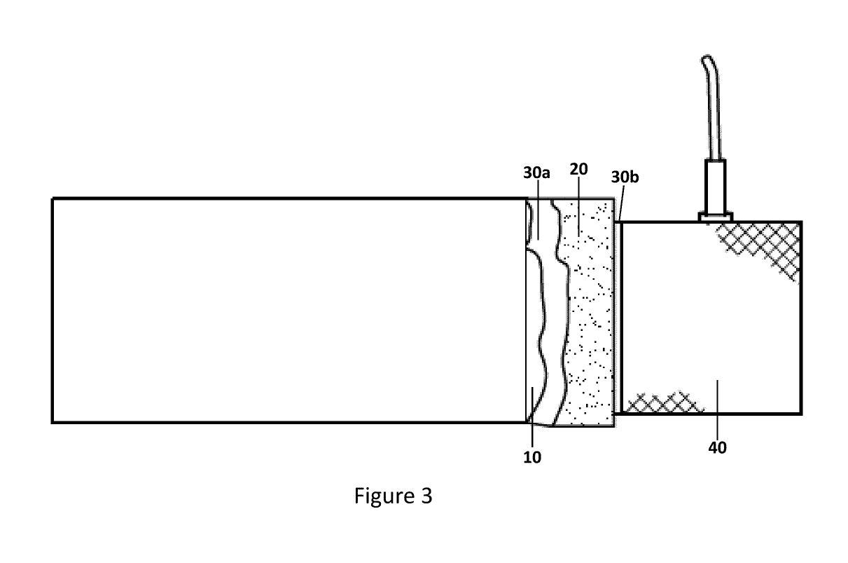

FIG. 3 illustrates exemplary system 200 for ultrasonically testing a trunnion rod in situ using a highly conductive transducer/rod-end interface conductive cap.

FIG. 3 illustrates trunnion rod end 10, conductive cap 20, sealant layers 30a-b, and transducer 40.

As illustrated in FIG. 3, trunnion rod end 10 is a rough and non-planar surface.

Structural variations in rod end surface roughness, rod end surface condition, rod diameter, and rod length may cause variations in mechanical impedance and determine relative reflection and refraction coefficients. Other structural changes may alter acoustical velocity and path length to drive destructive phase interactions in the test specimen.

In one exemplary embodiment, transducer 40 includes has a faceplate with a wear plate that is one-quarter wavelength of Alumina material, which has an acoustical impedance of 40.6 MRayls.

In the embodiment shown, conductive cap 20 includes a contoured inner surface that corresponds to surface irregularities of trunnion rod end 10 and a substantially smooth outer surface. In one exemplary embodiment, conductive cap 20 may have an impedance of 42.4 MRayls. To minimize destructive reverberations and phase in conductive cap 20, it is desirable to have a coupling material with an acoustical velocity of approximately 5900 m/s.

In one exemplary embodiment, the most effective acoustical conductive cap 20 between the transducer has a thickness that is an odd increment of a quarter of a wavelength and may have an acoustical impedance that is the geometric mean between the rod and transducer. For example, transducer wear plates may be one-quarter wavelength of Alumina material, which has an acoustical impedance of 40.6 MRayls. Trunnion rod steel's acoustical impedance is approximately 45 MRayls. Therefore, the geometric mean would be 42.4 MRayls.

In various embodiments, sealant layers 30a-b may be applied. Sealant may include water or grease, including petroleum grease. Conductive caps do not form an adhesive bond with the rod or casting apparatus. Due to this lack of adhesion, a small, thin layer of sealant is applied to each side to form good ultrasonic coupling. If a test surface is relatively smooth, a thin film of sealant is often used to transfer the ultrasonic energy from the transducer face into the test object.

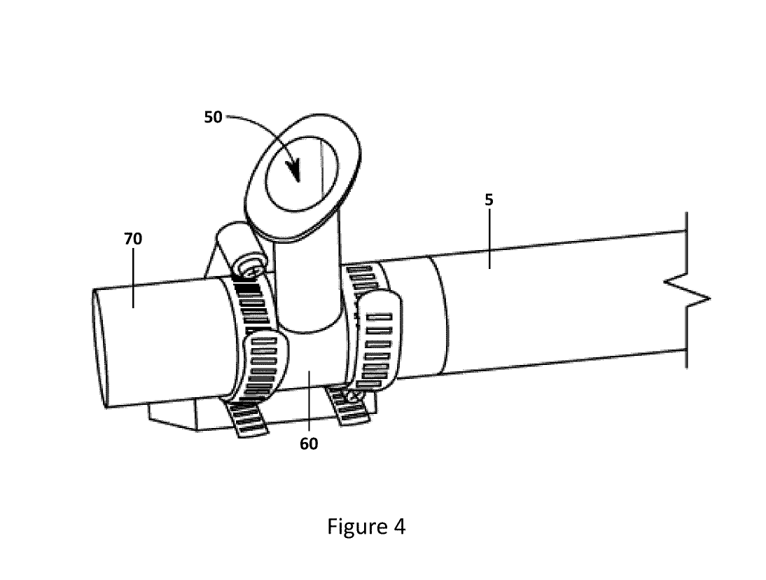

FIG. 4 illustrates an exemplary embodiment of the cast used for molding the conductive cap.

FIG. 4 includes trunnion rod 5, melted alloy fill chamber 50, cast cavity 60, and smooth backing 70.

In the embodiment shown, the cast utilizes the surface of the rough end of trunnion rod 5, creating a corresponding irregular inner surface in the conductive cap. Melted alloy fill chamber 50 acts as a funnel to direct liquid metal into cast cavity 60.

In the embodiment shown, cast cavity 60 has smooth backing 70 opposite the rough end of trunnion rod 5. In this embodiment, smooth backing 70 allows the trunnion rod to be oriented at any angle during casting.

In the embodiment shown, cast cavity 60 includes a vent hole at the highest point of cast cavity 60, to provide an escape route for excess liquid metal injected into cast cavity 60. In various embodiments, adjustments may be made to the cast to change the thickness of the resulting metal conductive cap.

In alternative embodiments, cast cavity 60 has an open end opposite the rough end of trunnion rod 5. A cast with an open end opposite the trunnion rod depends on the force of gravity to form the flat backing of the metal coupling that will contact the transducer face, which requires the trunnion rod to be oriented vertically.

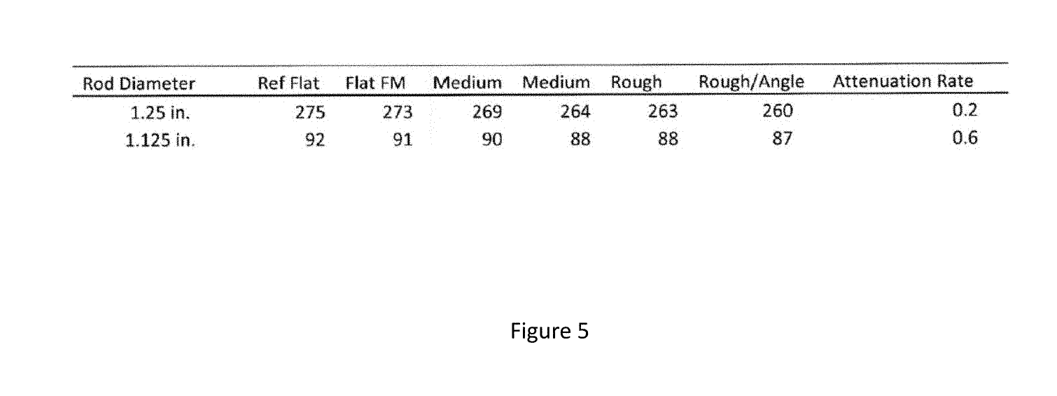

FIG. 5 illustrates how acoustic trunnion rod testing is affected by variations in surface roughness, rod end surface condition, rod diameter, and rod length.

FIG. 5 illustrates testable trunnion rod lengths in feet and can be used to determine the amount of surface preparations to be done for the given rod surface condition, length, and diameter.

Surface roughness creates frequency-dependent scattering which can be detected and measured with spectral guided wave scans. Rougher surface conditions produce more attenuation and scattering.

Results for five categories of rods are shown, including a smooth control (“Ref flat”), a rod cut with a portable bandsaw (“flat FM”), two rods with an end grinded for several minutes to reduce surface roughness (“medium”), a rough cut rod end having a 90 degree angle (orthogonal) to the rod length (“Rough”), and a rough cut rod end having a non-90-degree angle (not orthogonal) to the rod length (“Rough/angle”).

What is claimed is:

1. A method for making a highly conductive transducer/rod-end interface structure comprised of the steps of:
selecting a metal with a melting point that can be achieved in situ;
creating a metal cast of a non-uniform rod end surface;
casting a metal conductive cap wherein said metal conductive cap includes a contoured inner surface and a substantially smooth outer surface; and
wherein said contoured inner surface corresponds to surface irregularities of said non-uniform rod end surface.

2. The method of claim 1, which further includes the step of cutting a rod end to create a rod-end surface oriented approximately 90 degrees relative to said rod.

3. The method of claim 1, which further includes the step of reducing surface roughness of said non-uniform rod end surface.

4. The method of claim 4, wherein surface roughness is reduced until each instance of surface variation on said non-uniform rod end surface has a maximum height of 0.01 inches.

5. The method of claim 1, wherein the step of selecting said metal further includes selecting a metal that has a melting point temperature from approximately 32° C. to 38° C.

6. The method of claim 1, wherein the step of selecting said metal further includes selecting said metal from a group consisting of gallium, Field's metal, Rose's metal, and Wood's metal.

7. A rod-end interface apparatus comprised of:
a conductive cap affixed to a rod end surface to form a rod end interface;
wherein said conductive cap includes a contoured inner surface and a substantially smooth outer surface; and
and the inner surface of said conductive cap conforms to surface deviations of said rod end surface.

8. The apparatus of claim 7, wherein said surface deviations include surface irregularities.

9. The apparatus of claim 8, wherein each of said surface irregularities has a maximum height of 0.01 inches.

10. The apparatus of claim 7, wherein said surface deviations include surface roughness.

11. The apparatus of claim 7, which further includes at least one sealant layer.

12. The apparatus of claim 11, wherein said at least one sealant layer is oil based.

13. The apparatus of claim 11, wherein said at least one sealant layer is water based.

14. The apparatus of claim 7, wherein said conductive cap is made from a material selected from a group consisting of gallium, Field's metal, Rose's metal, and Wood's metal.

15. The apparatus of claim 7, wherein said conductive cap is comprised of a metal having an acoustical velocity range that is approximately 2,600 m/s to 10,520 m/s.

16. The apparatus of claim 7, wherein said conductive cap is comprised of a metal having an impedance that is approximately 2 MRayls to 101 MRayls.

17. The apparatus of claim 7, wherein said conductive cap is comprised of a metal having a density that is approximately 3 g/m³ to 20 g/m³.

18. The apparatus of claim 7, wherein said conductive cap is comprised of a metal having a melting point that is approximately 32° C. to 38° C.

19. The apparatus of claim 7, wherein said conductive cap is comprised of a metal having a tensile strength that is approximately 33 MPa.

20. The apparatus of claim 7, wherein said conductive cap is comprised of a metal having a Young's modulus that is approximately 25 GPa.
